(19) United States
(12) Patent Application Publication
(10) Pub. No.: US 2002/0049850 A1
(43) Pub. Date: Apr. 25, 2002

(54) Data communications method and system

(75) Inventors: Costantino Fiori, Echirolles (FR); Christophe Guionneau, Grenoble (FR); Jacques Cayuela, La Tronche (FR)

Correspondence Address: YOUNG & THOMPSON, 745 SOUTH 23RD STREET 2ND FLOOR, ARLINGTON, VA, 22202

(73) Assignee: NETCELO

(21) Appl. No.: 09/983,233

(22) Filed: Oct. 23, 2001

(30) Foreign Application Priority Data
Oct. 24, 2000 (FR) 0013648

(51) Int. Cl. G06F 15/16

(52) U.S. Cl. 709/227

(57) ABSTRACT

Method and system for data communications between a first user station of a first network and a second user station of a second network via a network of the Internet type, in which, after an access terminal has obtained a public address intended for a communication between the first user station and the second user station, the access terminal is connected to the administrator, the administrator supplies the access terminal with connection data and supplies addressees with the connection data and the public address, and the access terminal establishes a communications tunnel with the second user station or with an access terminal of the second user station, then a communication with the second user station.

The present invention relates to communications on a network, especially an Internet network.

Means are known for exchanging data according to the TCP/IP protocol.

The invention proposes to provide a security-protected communications method.

The data communications method, according to one aspect of the invention, is provided between a first user station of a first network and a second user station of a second network via a network of the Internet type, in which, after an access terminal has obtained a public address intended for a communication between the first user station and the second user station, said access terminal is connected to the administrator, the administrator supplies said access terminal with connection data and supplies addressees with said connection data and said public address, and the access terminal establishes a communications tunnel with the second user station or with an access terminal of the second user station, then a communication with the second user station.

Said access terminal is preferably connected to the administrator by establishing a communications tunnel.

In one embodiment of the invention, said communications tunnel is encrypted.

Said access terminal preferably sends the administrator its public address and its identifier.

In one embodiment of the invention, the connection data supplied by the administrator to said access terminal comprise security rules and a list of access terminals to be alerted. The connection data can be supplied by the administrator to said access terminal before communications are established to other user stations.

In one embodiment of the invention, the communications tunnel between the access terminal and the administrator is destroyed once the administrator has supplied the access terminal with the connection data allowing the access terminal to establish communications tunnels to other user stations.

In one embodiment of the invention, at the end of the communication with the second user station, the communications tunnel is destroyed.

The access terminal preferably establishes a communications tunnel with another access terminal in communication with the second user station, then a communication with said other access terminal.

In one embodiment of the invention, the connection data supplied by the administrator to said access terminal are also supplied to the other access terminal.

The invention also proposes a data communications system comprising a first user station of a first network, an access terminal, a network administrator and a second user station of a second network, the network being of the Internet type. The access terminal comprises a means for obtaining a public address intended for a communication between the first user station and the second user station, a means for connecting to the administrator, and a means for establishing a communications tunnel with the second user station or with an access terminal of the second user station, then a communication with the second user station. The administrator comprises a means for supplying connection data to said access terminal and a means for supplying said connection data and said public address to addressees.

The invention also relates to a computer program comprising program-code means for implementing the stages of the method, when said program is running on a computer.

The invention also relates to a medium capable of being read by a device for reading program-code means which are stored thereon and which are suitable for implementing the stages of the method, when said program is running on a computer.

A dynamic configuration-obtaining protocol is implemented for systems using dynamic or static IP addresses. Before the user establishes a communication, security rules are implemented, then they are updated dynamically. The subscribers of the Internet network, private individuals, those from small-scale organizations or from small businesses access the Internet after having taken out a subscription with an Internet-access provider. In the majority of cases, this access takes place at the request of the subscriber for a given session, by means of an Internet address called dynamic public IP address which is allotted to him by his access provider. The public IP address is allocated by the access provider to the subscriber only for the time of the session requested and is destroyed when the subscriber puts a stop to it.

Two Internet users, who would gain access to the Internet network via their respective access terminals of the analog or digital modem type, for example ISDN or ADSL, router, cable modem, etc., cannot transfer and receive digital data directly from personal computer to personal computer unless they are able to exchange their respective IP addresses beforehand. It is possible to provide for an automatic exchange of the IP addresses before connections are established between the access terminals. It is also possible to provide for a solution to alert the remote access terminal if it is not already connected to the Internet.

The invention offers a dynamic and autonomous solution for forming direct connections on the Internet between the subscribers.

The invention applies to dynamic public IP addresses but also to static public addresses, and allows communications to be established between dynamic public addresses and static public IP addresses. In fact, in certain types of subscription, the access providers give a static public address in place of a dynamic public address.

In a general way, “tunnel” is understood here to mean the tunnels of IPSEC type as illustrated by the document “RFC 2401, Security Architecture for the Internet Protocol, November 1998, http://www.normos.org/ietf/rfc/rfc2401.txt, the L2TP tunnels, see the document “RFC 2661, Layer Two Tunneling Protocol L2TP” August 1999, http://www.rfc-editor.org/rfc/rfc2661.txt, or else any other type of tunnel, see the document “RFC 1853, IP in IP Tunneling, October 1995, http://www.rfc-editor.org/rfc/rfc1853.txt”, whether it is security protected or not security protected, with or without encryption key. It goes without saying that the use of the tunnels should be done in a coherent way, in particular, the IP addressing of the machines and of the systems brought into contact via a communications tunnel should be coherent. It is possible to establish a direct communication, via the Internet network, between a calling party and at least one called party lacking a permanent public address by sending, by the calling party, a message to a service control and administration system, the message including data specific to the calling party allowing said system to authorize the connection of the calling party, and a request for connection with the called party allowing said system to identify the called party, by verifying, by said system, that the called party is already in communication on the Internet network and has available a dynamic public address declared to the system, if the called party is not in Internet communication or if said system has no knowledge of him, by alerting the called party by the system via the switched telephone network, if appropriate establishing an Internet session by the called party, and by sending a message to the system, by the called party, the message including parameters for connection to the Internet network of the called party, by sending by the system of the connection parameters to the Internet network of the called party to the calling party and of the parameters for connection to the Internet network from the calling party to the called party, and, with the aid of the parameters for connection to the Internet network of the called party and of the calling party, by forming a direct communications channel between the calling party and the called party, via the Internet network.

The data specific to the calling party which are sent to the system comprise the dynamic public address of the calling party and, if appropriate, at least one element such as the number, line number, name, identifier, password, identification data of the calling party, etc.

The present invention will be better understood on studying the detailed description of an embodiment taken by way of non-limiting example, and illustrated by the attached drawing, in which:

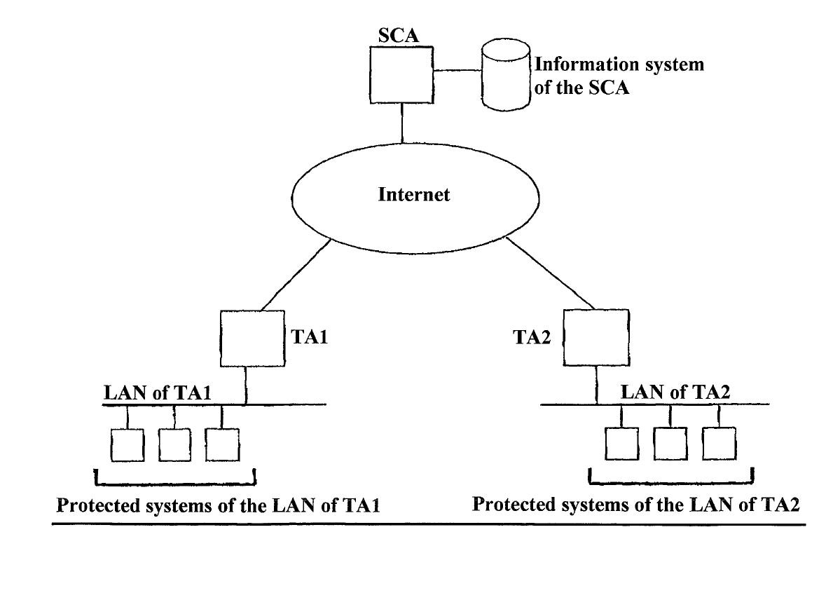

FIG. 1 is a diagrammatic view of the architecture of an Internet network.

As can be seen in the FIGURE, a control and administration system SCA is provided with an information system, for example a database, and linked to the Internet network by cable, optical fiber or otherwise. A number of access terminals TA are also linked to the Internet network. Here, the access terminals TA1 and TA2 have been represented. Each access terminal TA1 and TA2 is linked to a local-area network LAN provided with a number of routers, not represented, themselves linked to the interfaces with the subscribers, for example to their personal computers, also called protected systems.

The control and administration system SCA is permanently linked to the Internet network and has available a fixed IP address. On condition that the users hold rights of access from the administrator of the SCA system, the access terminals TA1, TA2 can be connected on request to the SCA, via the Internet network, and can thus have access to the services supplied by it. The information system of the SCA system contains information on the access terminals, on the protected systems of the access terminals, the rights of the access terminals and of the protected systems, etc. The information system may be a database, an LDAP directory, see the document “RFC 2251 Lightweight Directory Access Protocol (V3), December 1997, http://www.rfc-editor.org/rfc/rfc2251.txt” or any other system making it possible to store information. The users' computers are connected to the respective access terminals TA1, TA2 and protected by them.

More precisely, the access terminals TA1, TA2 are the interfaces between the local-area network LAN of the subscriber and the Internet network. The access terminals are connected to the Internet via a connection protocol on request, and use the public IP address allocated by the Internet access provider to which they are affiliated. The access terminals are connected to the control and administration system SCA upon each Internet re-connection in order to signal their presence, in order to supply their new public IP address and in order to receive their security policy. The access terminals TA1, TA2 are able to create communications tunnels, are the initiators of alerting requests to the other access terminals from the control and administration system SCA and are the initiators of the connections to the other access terminals by establishing a tunnel.

The control and administration system SCA is permanently connected to the Internet network and has available one or more fixed IP addresses known to the access terminals TA. The control and administration system receives the signaling of the Internet connections of the access terminals TA and asks them for their security rules, the requests for automatic alerting of the access terminals wishing to establish connections to other access terminals which are not connected to the Internet and supplies updates of the security rules to the access terminals TA in step with the connections and disconnections of the access terminals on the Internet and with the obtaining of new, dynamic or static, public IP addresses.

Periodically, the system SCA checks the security rules and the state of the access terminals TA, the tunnels established by the access terminals TA while possessing the capacity to destroy them, and verifies that the access terminals TA are still connected to the Internet while updating the security rules for the corresponding access terminals in the case of abrupt disconnection from the Internet. The control and administration system SCA does not intervene in the establishing of the tunnels between the access terminals, communications which are established between the access terminals TA autonomously.

In operation, it is sought to set up communications from the access terminal TA1, taken to be the sender, to the access terminal TA2, taken to be the receiver. Setting up communications between TA1 and TA2 does not necessarily take place by way of the control and administration system. Nevertheless, the control and administration system controls and distributes the up-to-date security rules to the access terminals TA in order to authorize the establishing of their communication.

Let us consider a subscriber who accesses the Internet network via an ISDN link through the access terminal TA1. The access terminals TA1 and TA2 are declared in the information system of the SCA as forming part of a same group and hold the right of communicating with each other. It is assumed that the access terminal TA1 possesses the right of establishing connections with the access terminal TA2, and it is assumed that the access terminal TA2 is already connected to the Internet.

When a user of the access terminal TA1 tries to establish an outgoing connection, the on-request connection mechanism establishes the Internet connection to the Internet access provider, not represented, who allocates a public IP address to the access terminal TA1. When the access terminal TA1 has obtained its public IP address, it is connected to the control and administration system SCA through an IP tunnel, encrypted or otherwise. The access terminal TA1 supplies its own public IP address and its identification to the SCA, either in the same connection, or by a call from the SCA to the access terminal TA1 in order to verify its identity on the switched network, ISDN, ADSL, etc. Identification is understood to mean the name, telephone number, MAC address, see the document “Medium Access Control, http://www.ieee.org/”, unique identification or serial number, etc. The control and administration system supplies the access terminal TA1 with its security rules, that is to say a list of security rules to be applied so that the access terminal TA1 can directly establish its Internet connections to its correspondents. The access terminal TA1 may, by configuration, agree or refuse to open its communications as long as it has not obtained its security rules. In the case in which the access terminal TA1 is not waiting for the security rules, it is convenient to agree to apply preceding security rules, which may possibly be erroneous or void.

The access terminal TA1 also receives the list of access terminals TAi, i being other than 1, to be alerted before trying to establish Internet communications to the IP addresses of this correspondent. This list is also called alerting policy. The control and administration system transmits to each of the access terminals which are authorized correspondents of the access terminal TA1 and are declared in the information system of the SCA, an update of the security rules of said access terminals TAi, i being other than 1, with the new public IP address of the access terminal TA1.

More precisely, the communication can be established according to the following stages:

stage 1: a user of the access terminal TA1 attempts to establish an outgoing communication through the access terminal TA1.

stage 2: the on-request connection mechanism connects the access terminal TA1 to the Internet, and said access terminal TA1 receives a public IP address.

stage 3: the access terminal TA1 is connected to the control and administration system SCA through a tunnel and supplies its own IP address and its own identity to the system SCA.

stage 4: the system SCA constructs security rules for the terminal TA1 with the data of its information system and with the public IP addresses obtained by the possible correspondents of the terminal TA1 already connected to the Internet.

stage 5: the SCA system constructs the lists of the terminals TAi, i being other than 1, which are capable of corresponding with the terminal TA1 and which have to be alerted before attempting a communication to the IP addresses protected by the terminals TAi, i being other than 1.

stage 6: the system SCA transmits to the terminal TA1 the security rules and the encryption keys of the other terminals TAi, i being other than 1, capable of corresponding with the terminal TA1.

stage 7: the system SCA transmits to the terminal TA1 the list of the other access terminals TAi, i being other than 1, to be alerted and the associated and protected IP addresses. With the terminal TA2 already being alerted, the system SCA may decide not to include the terminal TA2 in the list of the other terminals to be alerted in order to avoid the terminal TA1 making nuisance alerting requests.

stage 8: the system SCA verifies that the terminal TA1 has actually taken into account all of its new rules.

stage 9: for each of the correspondents of the terminal TA11, here the terminal TA2 only, the system SCA constructs an update of the security rules with the new public IP address of TA1.

stage 10: the system SCA transmits to the terminal TA2 an update of its security rules containing a rule with the new public IP address of the terminal TA1 and the key of the encryption which is necessary for establishing the tunnel between the terminals TA2 and TA1. The system SCA transmits to the terminal TA2 an update of the alerting policy for the latter.

stage 11: the communication between the terminal TA1 and the system SCA is terminated, and the tunnel between the terminal TA1 and the system SCA is destroyed.

At this stage, the system SCA has supplied the terminal TA1 with new security and alerting rules, and the terminal TA2 with an update of its rules. For reasons of synchronization, it may prove to be preferable to transfer the security rules and the alerting policy to the terminals TA1 and TA2 and to ratify them simultaneously rather than applying them one by one. If the security and alerting rules are applied independently, there may exist a period of time during which the communications attempts may fail or may give rise to defective security.

Let us now consider a subscriber who accesses the Internet network through the terminal TA1. It is assumed that the terminals TA1 and TA2 are connected to the Internet and have obtained their security rules from the system SCA.

In the course of a stage 12, a protected system on the network LAN of the access terminal TA1 attempts to establish an IP communication with a protected system of the network LAN of the terminal TA2.

stage 13: the terminal TA1 detects, via appropriate means such as a routing table, a request for communication from a system of its local-area network LAN to a system of the local-area network LAN of the terminal TA2. For further information on routing tables, reference can be made to the document “RFC 1812 Requirements for IP Version 4 Routers, June 1995: http://www.rfc-editor.org/rfc/rfc1812.txt”

stage 14: a tunnel, of IPSEC type for example, is established between the terminals TA1 and TA2.

stage 15: communication is established between the IP address of the sending system and the IP address of the destination system through the tunnel.

stage 16: possibly on the basis of security rules, the terminals TA1 and TA2 signal to the system SCA the establishing of a tunnel respectively at the output of the terminal TA1 and at the input of the terminal TA2.

stage 17: when there is no further activity on the communications passing through the tunnel established between the terminals TA1 and TA2, or at the initiative of one of the two terminals, the tunnel is destroyed and, possibly depending on the configuration of the terminals TA1, TA2, these signal to the system SCA the destruction of the tunnels.

The system SCA may, at any moment, during the use of the tunnel, ask the terminal TA1 or the terminal TA2 for destruction of the tunnel following a request made by an authorized user, from a dedicated WEB page for example. Likewise, at any moment, the terminals TA1 and TA2 may receive an update of their security policy invalidating the use of a tunnel established according to the preceding security rules.

Let us suppose now that the establishing of communications requires the terminal TA2 to be alerted.

It is therefore assumed that the terminal TA2 is not connected to the Internet, but that the terminal TA1 has the right to ask the system SCA to alert the terminal TA2.

stage 18: a system of the terminal TA1 wishes to establish a communication through the terminal TA1 and via the Internet network to a system of the terminal TA2.

stage 19: the terminal TA1 detects a request for communications from a system of its local-area network LAN to a system of the local-area network LAN of the terminal TA2.

stage 20: the terminal TA1 does not possess, in its security rules, the public IP address of the terminal TA2. The terminal TA2 is in the list of the terminals TAi, i being other than 1, to be alerted before establishing a communication.

stage 21: the terminal TA1 is connected to the system SCA through a tunnel.

stage 22: the system SCA verifies the identity of the terminal TA2 through information supplied by the terminal TA1 and information contained in the information system.

stage 23: the terminal TA1 asks the system SCA to alert the terminal TA2.

stage 24: the alerting of the terminal TA2 is activated by the system SCA if the terminal TA1 is authorized to alert the terminal TA2. The system SCA has available the necessary means for carrying out the alerting, synchronously, the terminal TA1 being on standby for the alerting of the terminal TA2, or synchronously. The terminal TA1 does not wait for the end of the alerting of the terminal TA2. It is assumed in what follows that the alerting is carried out synchronously.

stage 25: the terminal TA2 receives the alert request and responds via an Internet connection in order to access the system SCA, which activates the procedure described above by reference to stages 1 to 11.

stage 26: when the terminal TA2 has given effect to its security rules, it signals to the system SCA the end of its alerting.

stage 27: the communication between the terminal TA2 and the system SCA is terminated and the tunnel between the terminal TA2 and the system SCA is destroyed.

stage 28: the terminal TA1 receives from the system SCA the update of its security rules, puts them into effect and can therefore establish a communication with the terminal TA2, see above, stages 12 to 17.

stage 29: the communication between the access terminal TA1 and the system SCA is terminated and the TAL-SCA tunnel is destroyed after the system SCA has supplied the terminal TA1 with the update of its security rules.

In the case of the alerting, the terminal TA1 cannot establish a tunnel to the terminal TA2 and does not have available the IP address of the terminal TA2, nor the encryption keys necessary to establish the tunnel to the terminal TA2. The communication which required this tunnel to be established is either placed on hold, or rejected until the terminal TA1 receives an update of its security rules and of its alerting policy when the terminal TA2 has finished its alerting phase. In the event of a communication being placed on hold, the standard mechanisms for re-sending of the TCP/IP or UDP/IP type can allow the communication to be established without inconvenience to the users.

In the event that the communication is rejected or the re-sending mechanisms do not allow the communication to be re-established, the user will have to repeat his attempt at communication.

In a general way, a terminal TA, after having been re-connected to the Internet and having obtained a public IP address, is connected to the system SCA through a tunnel and gives it its public IP address and its identifier, for example a unique identifier allocated by the service and stored in the access terminal SCA, a unique number of its equipment, a MAC address of one of its interfaces or else its telephone-call number.

The system SCA can process its data directly or indirectly by relying on an information system to verify whether the terminal TA is known to the system and whether the terminal TA should receive security rules and/or an alerting policy. The system SCA constructs the information necessary for the terminal TA and supplies it with its security rules to be applied to the Internet connections, the security rules applying only to valid IP addresses of its corresponding access terminals, the list of the other accessed terminals which have to be alerted before establishing communications to the list of IP addresses of their protected system, and the encryption keys necessary to establish the tunnels. The system SCA constructs an update of the security rules and of the alerting policy of the accessed terminals capable of corresponding with a terminal TA which has just been connected and of obtaining a public IP address. The terminal TA applies the initial security rules which are delivered to it by the system SCA as well as the update of its policies. The terminal TA applies the initial alerting policies which are delivered to it by the system SCA as well as the updates of its alerting policies.

The terminal TA1 applies the current security rules in order to open the tunnel to the terminal TA2 by its own means, by detecting that a tunnel should be created and open to the terminal TA2 in order to reach the destination IP address, and using the public IP address of the terminal TA2 delivered by the system SCA, establishing the tunnel to the terminal TA2 independently of the system SCA but by using the policies delivered by the system SCA, and by signaling the establishing and the destruction of the tunnel to the system SCA. The signaling of the establishing and the destruction of the tunnel are optional, and can be configured in the security rules.

The access terminal TA1 can establish a communication by a tunnel to the terminal TA2, even when the latter might not be connected to the Internet, by using the alerting policy of the access terminal TA1 in order to determine whether the terminal TA2 can be alerted, an alerting request as required by the system SCA through a tunnel between the terminal TA1 and the system SCA, and an update of the security rules of the terminal TA1 containing the information necessary for establishing the tunnel from the terminal TA2 and the implementing of the communications to the protected systems by the terminal TA2.

The system SCA can receive the alerting requests from the terminal TA1 and alert the terminal TA2 after having verified that the terminal TA1 has the right to alert the terminal TA2 and that the terminal TA2 is not already connected to the network and does not already possess a public address.

The terminal TA2 which receives an alerting signal is connected to the Internet by its own means and communicates with the system SCA through a tunnel in order to signal, to the system SCA, its public IP address, to obtain security rules and an alerting policy relating to the access terminals with which the terminal TA2 can obtain a communication and to sign off from the system SCA at the end of the procedure for alerting the terminal TA2.

The system SCA can construct, and supply to the correspondent of an access terminal which has just been connected after an alerting, an update of the security rules of said correspondents, an update of the alerting policies of said correspondents and an update of the encryption keys necessary for establishing tunnels between said correspondents and the terminal TA which has just been connected.

The system SCA can, at any moment, ask a terminal TA for its security rules and its alerting policy so as to compare them with the data stored in its information system in order to verify that there have not been any unauthorized changes by a system other than the system SCA. The system SCA can, at any moment, ask a terminal TA for the list of the operational tunnels and to close one of them upon request from an authorized user.

1. A method of data communications between a first user station of a first network and a second user station of a second network via a network of the Internet type, in which:
after an access terminal has obtained a public address intended for a communication between the first user station and the second user station, said access terminal is connected to the administrator, the administrator supplies said access terminal with connection data and supplies addressees with said connection data and said public address,
the access terminal establishes a communications tunnel with the second user station or with an access terminal of the second user station, then a communication with the second user station.

2. The method as claimed in claim 1, in which said access terminal is connected to the administrator by establishing a communications tunnel.

3. The method as claimed in claim 2, in which said communications tunnel is encrypted.

4. The method as claimed in any one of the preceding claims, in which said access terminal sends the administrator its public address and its identifier.

5. The method as claimed in any one of the preceding claims, in which the connection data supplied by the administrator to said access terminal comprise security rules and a list of access terminals to be alerted.

6. The method as claimed in any one of the preceding claims, in which the communications tunnel between the access terminal and the administrator is destroyed once the administrator has supplied the access terminal with the connection data allowing the access terminal to establish communications tunnels to other user stations.

7. The method as claimed in any one of the preceding claims, in which, at the end of the communication with the second user station, the communications tunnel is destroyed.

8. The method as claimed in any one of the preceding claims, in which the access terminal establishes a communications tunnel with another access terminal in communication with the second user station, then a communication with said other access terminal.

9. The method as claimed in claim 8, in which the connection data supplied by the administrator to said access terminal are also supplied to the other access terminal.

10. A data communications system comprising a first user station of a first network, an access terminal (TA), a network administrator (SCA) and a second user station of a second network, the network being of the Internet type, wherein the access terminal comprises a means for obtaining a public address intended for a communication between the first user station and the second user station, a means for connecting to the administrator, and a means for establishing a communications tunnel with the second user station or with an access terminal of the second user station, then a communication with the second user station, and the administrator comprises a means for supplying connection data to said access terminal and a means for supplying said connection data and said public address to addressees.

11. A computer program comprising program-code means for implementing the stages of the method according to any one of claims 1 to 9, when said program is running on a computer.

12. A medium capable of being read by a device for reading program-code means which are stored thereon and which are suitable for implementing the stages of the method according to any one of claims 1 to 9, when said program is running on a computer.
